(19) United States
(12) Patent Application Publication
(10) Pub. No.: US 2014/0003789 A1
(43) Pub. Date: Jan. 2, 2014

(54) PLAYBACK OF VIDEO CONTENT BASED ON FRAME-LEVEL RATINGS

(71) Applicant: Chandra M. Konduru, Folsom, CA (US)

(72) Inventor: Chandra M. Konduru, Folsom, CA (US)

(21) Appl. No.: 13/997,062

(22) PCT Filed: Dec. 30, 2011
(86) PCT No.: PCT/US11/68029

§ 371 Date: Sep. 18, 2013

(51) Int. Cl. H04N 9/87

(52) U.S. Cl. CPC H04N 9/87
USPC 386/230; 386/261; 386/200

(57) ABSTRACT

Methods and apparatuses to play video content on a frame-by-frame basis according to frame level ratings are provided. A video encoder can be configured to encode a video program with a corresponding rating for each frame of a plurality of frames of the video program based on the content of the frame. A playback device can be configured to play the encoded video program on the video playback device based on frame level ratings of the video program set by a user.

### BACKGROUND

Video content such as movies and television shows can be classified or rated, for example, according to its content to help a viewer decide whether to watch or allow others (e.g., children) to watch the video content. Existing video playback devices can enable video content to be blocked based on the rating of the video content. Thus, a user may be able to set a playback device to block from playback any video content having a certain rating. However, with existing rating systems, if any portion of a video program (such as movie) meets the criteria for a particular rating, the entire video program may be designated with the particular rating. Accordingly, existing video playback devices may block an entire video program based on a user setting even if only a portion of the video program has the restricted rating.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram illustrating an example system to encode video content to enable playback of the video content on a frame-by-frame basis according to frame level ratings according to an embodiment;

FIG. 2 is a block diagram illustrating an example playback device to playback video content on a frame-by-frame basis according to frame level ratings according to an embodiment;

FIG. 3 illustrates example processes to use frame level ratings to playback video content on a frame-by-frame basis according to embodiments;

FIG. 4 is a block diagram illustrating an example system of this disclosure; and

FIG. 5 is a block diagram illustrating an example small form factor device in which components of the system of FIG. 4 may be embodied.

### DETAILED DESCRIPTION

Various implementations of this disclosure provide apparatuses and methods to playback video content on a frame-by-frame basis according to frame level ratings.

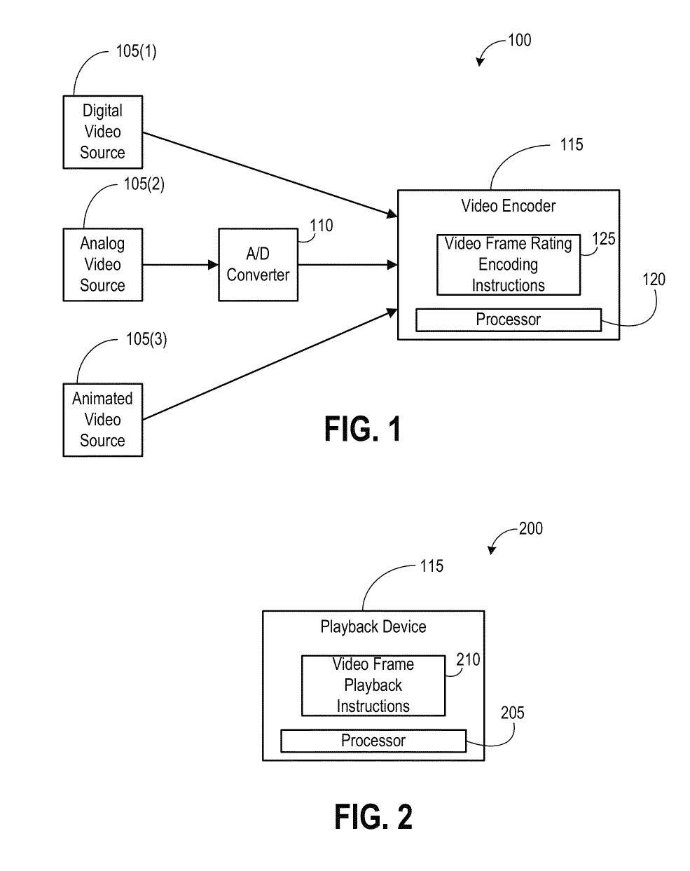

FIG. 1 illustrates an example system 100 to encode video content to enable playback of the video content on a frame-by-frame basis according to frame level ratings. The system 100 may include various video sources 105 such as a digital video source 105(1) (e.g., a digital camera), an analog video source 105(2) (e.g., an analog camera), or an animated video source 105(3). The system 100 also may include an analog-to-digital converter 110 to convert an analog video program to a digital video program.

The system 100 also may include a video encoder 115 to encode the uncompressed digital video received from the various video sources. For example, the video encoder 115 may include an MPEG-2 (Moving Picture Experts Group—2, e.g., International Standards for Organization; ISO/IEC 13818-11:2004, January 2004) or an MPEG-4 (e.g., ISO/IEC 14496-15:2010, May 2010) codec to encode the digital video. The video encoder 115 may encode a video program using coded frames (e.g., intra-coded frames (i-frames), predicted frames (p-frames), and bi-directional predicted frames (b-frames)) such as defined in the MPEG-2 standard, for example. Each frame of the video program can include a frame header. In alternate implementations, the video program can be encoded based on VC1, Windows Media Video (WMV), VP8, Advanced Video Coding (AVC), Scalable Video Coding (SVC), or an uncompressed format, for example. This disclosure is not limited to any particular codec.

The video encoder 115 also may include a processor 120 that executes video frame rating encoding instructions 125. The video frame rating encoding instructions 125 when executed can launch a user interface to enable a producer to rate each frame of a video program. The rating for each frame can be included in the header of each frame. In some implementations, the user interface can permit a user to identify and rate a group of frames. The video rating instructions 125 can then mark each frame header of each frame of the group of frames with the particular rating. In this way, as discussed below, the video program can be played back on a frame-by-frame basis according to each frame level rating. In alternative implementations, the video rating instructions 125 can encode the frame rating in a frame trailer, video header, or video trailer, for example. This disclosure is not limited to any particular location for encoding the frame rating information.

FIG. 2 illustrates an example playback device 200 to playback video content on a frame-by-frame basis according to frame level ratings. The playback device 200 may include a processor 205 that executes video frame playback instructions 210. The video frame playback instructions 210 when executed may launch a user interface to enable a user to program the playback device 200 to playback a video program based on frame level ratings of the video program. For example, the video frame playback instructions 210 when executed can launch a user interface to enable a user to set a playback device 200 to block from playback any frame having a certain rating. In some implementations, the video playback device 200 can be set to skip any video and audio frame having a certain rating. In some implementations, the video playback device 200 can be set to blur any video frame having a certain rating but play the corresponding audio frame. In some implementations, the video playback device 200 can be set to play an alternative frame for any video frame having a certain rating.

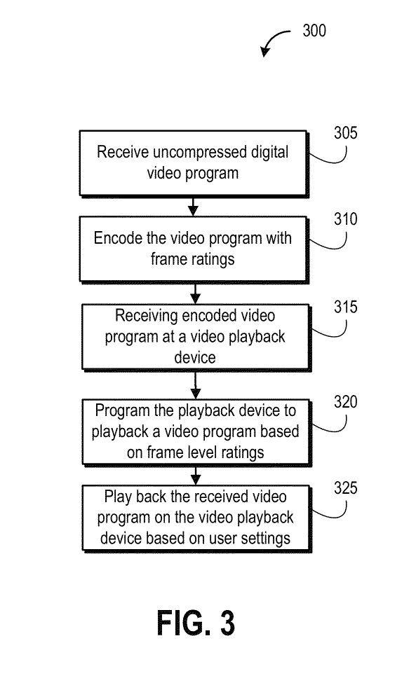

FIG. 3 illustrates an example process 300 to playback video content on a frame-by-frame basis according to frame level ratings.

At stage 305, an uncompressed digital video program is received by a video encoder.

At stage 310, video frame rating encoding instructions are executed to enable a producer to encode the video program with a particular rating for each frame of the video program.

At stage 315, the encoded video program is received at a video playback device.

At stage 320, video frame playback instructions are executed to enable a user to program the playback device to playback a video program based on frame level ratings of the video program.

At stage 325, the video playback device plays back the video program based on the user settings. The video program can be played back via an integrated screen of the video playback device or on a separately connected display.

Playback devices contemplated to be within the scope of this disclosure include personal computers (PCs), laptop computers, ultra-laptop computers, tablets, touch pads, portable computers, handheld computers, palmtop computers, personal digital assistants (PDAs), cellular telephones, combination cellular telephones/PDAs, televisions, smart devices (e.g., smart phones, smart tablets or smart televisions), mobile internet devices (MIDs), messaging devices, data communication devices, gaming consoles, portable gaming devices, set-top-boxes, IPTV boxes, DVD players, Blu-ray players or any playback capable devices.

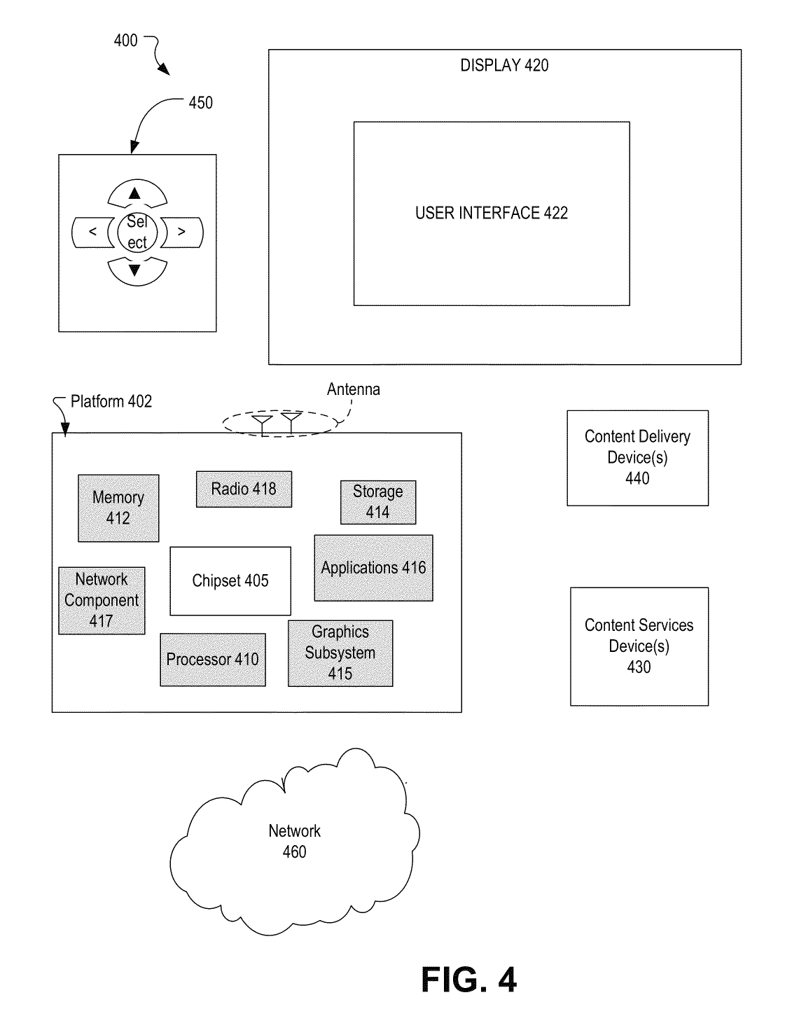

FIG. 4 illustrates an example embodiment of a system 400 of this disclosure comprising a platform 402, a display 420, content services device(s) 430, content delivery device(s) 440, and navigation controller 450. In embodiments, system 400 may be a media system although system 400 is not limited to this context. For example, components of system 400 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, gaming consoles, portable gaming devices, set-top-boxes, IPTV box, DVD players, Blu-ray players, or any playback capable devices.

In embodiments, system 400 comprises a platform 402 coupled to a display 420. Platform 402 may receive content from a content device such as content services device(s) 430 or content delivery device(s) 440 or other similar content sources. A navigation controller 450 comprising one or more navigation features may be used to interact with, for example, platform 402 and/or display 420. Each of these components is described in more detail below.

In embodiments, platform 402 may comprise any combination of a chipset 405, processor 410, memory 412, storage 414, graphics subsystem 415, applications 416, network component 417, and/or radio 418. Chipset 405 may provide intercommunication among processor 410, memory 412, storage 414, graphics subsystem 415, applications 416 and/or radio 418. For example, chipset 405 may include a storage adapter (not depicted) capable of providing intercommunication with storage 414.

Processor 410 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 410 may comprise single-core or multi-core processor(s), single-core or multi-core mobile processor(s), and so forth.

Memory 412 may be implemented as a volatile memory device such as, but not limited to, a Random Access Memory (RAM), Dynamic Random Access Memory (DRAM), or Static RAM (SRAM).). In some embodiments, memory 412 may be implemented as a non-volatile memory such as a flash memory device.

Storage 414 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 414 may comprise technology to increase the storage performance enhanced protection for valuable digital media when multiple hard drives are included, for example.

Graphics subsystem 415 may perform processing of images such as still images or video for display. Graphics subsystem 415 may be a graphics processing unit (GPU) or a visual processing unit (VPU), for example. An analog or digital interface may be used to communicatively couple graphics subsystem 415 and display 420. For example, the interface may be any of a High-Definition Multimedia Interface, DisplayPort, wireless HDMI, and/or wireless HD compliant techniques. In embodiments, graphics subsystem 415 could be integrated into processor 410 or chipset 405. In embodiments, graphics subsystem 415 could be a stand-alone card communicatively coupled to chipset 405. Graphics subsystem could be part of system-on-a-chip (SoC) devices.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 418 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 418 may operate in accordance with one or more applicable standards in any version.

The network component 417 may include one or more network components capable of transmitting and receiving signals using various suitable wired and/or wireless communications techniques. Such techniques may involve communications across one or more wired and/or wireless networks. In communicating across such networks, network component 417 may operate in accordance with one or more applicable standards in any version.

In embodiments, display 420 may comprise any television type monitor or display. Display 420 may comprise, for example, a computer display screen, touch screen display, video monitor, television-like device, projector and/or a television. Display 420 may be digital and/or analog. In embodiments, display 420 may be a holographic display. Also, display 420 may be a transparent surface that may receive a visual projection. Such projections may convey various forms of information, images, and/or objects. For example, such projections may be a visual overlay for a mobile augmented reality (MAR) application. Under the control of one or more applications 416 (e.g., software/firmware or hardware), platform 402 may display user interface 422 on display 420 and/or on a navigator.

In embodiments, content services device(s) 430 may be hosted by any national, international and/or independent service and thus accessible to platform 402 via the Internet, for example. Content services device(s) 430 may be coupled to platform 402 and/or to display 420. Platform 402 and/or content services device(s) 430 may be coupled to a network 460 to communicate (e.g., send and/or receive) media information to and from network 460. Content delivery device(s) 440 also may be coupled to platform 402 and/or to display 420.

In embodiments, content services device(s) 430 may comprise a cable television box, personal computer, network, telephone, camera, Internet enabled devices or appliance capable of delivering digital information and/or content, and any other similar device capable of unidirectionally or bidirectionally communicating content between content providers and platform 402 and/display 420 directly or via network 460. It will be appreciated that the content may be communicated unidirectionally and/or bidirectionally to and from any one of the components in system 400 and a content provider via network 460. Examples of content may include any media information including, for example, video, music, medical and gaming information, and so forth.

Content services device(s) 430 receives content such as cable television programming including media information, digital information, and/or other content. Examples of content providers may include any cable or satellite television or radio or Internet content providers. The provided examples are not meant to limit embodiments of the invention.

In embodiments, platform 402 may receive control signals from navigation controller 450 having one or more navigation features. The navigation features of controller 450 may be used to interact with user interface 422, for example. In embodiments, navigation controller 450 may be a pointing device, a control pad, a keyboard, or a touch screen device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 450 may be echoed on a display (e.g., display 420) by movements of a pointer, cursor, focus ring, or other visual indicators displayed on the display. For example, under the control of applications 416, the navigation features located on navigation controller 450 may be mapped to virtual navigation features displayed on user interface 422, for example. In embodiments, controller 450 may not be a separate component but integrated into platform 402 and/or display 420. Embodiments, however, are not limited to the elements or in the context shown or described herein.

In embodiments, drivers (not shown) may comprise technology to enable users to instantly turn on and off platform 402 like a television with the touch of a button after initial boot-up, when enabled, for example. Program logic may allow platform 402 to stream content to media adaptors or other content services device(s) 430 or content delivery device(s) 440 when the platform is turned “off” In addition, chip set 405 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 400 may be integrated. For example, platform 402 and content services device(s) 430 may be integrated, or platform 402 and content delivery device(s) 440 may be integrated, or platform 402, content services device(s) 430, and content delivery device(s) 440 may be integrated, for example. In various embodiments, platform 402 and display 420 may be an integrated unit. Display 420 and content service device(s) 430 may be integrated, or display 420 and content delivery device(s) 440 may be integrated, for example. These examples are not meant to limit the invention.

In various embodiments, system 400 may be implemented as a wireless system, a wired system, or a combination of both. When implemented as a wireless system, system 400 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 400 may include components and interfaces suitable for communicating over wired communications media, such as input/output (I/O) adapters, physical connectors to connect the I/O adapter with a corresponding wired communications medium, a network interface card (NIC), network controller (e.g. an Ethernet controller and ports (integrated or external), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 402 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 4.

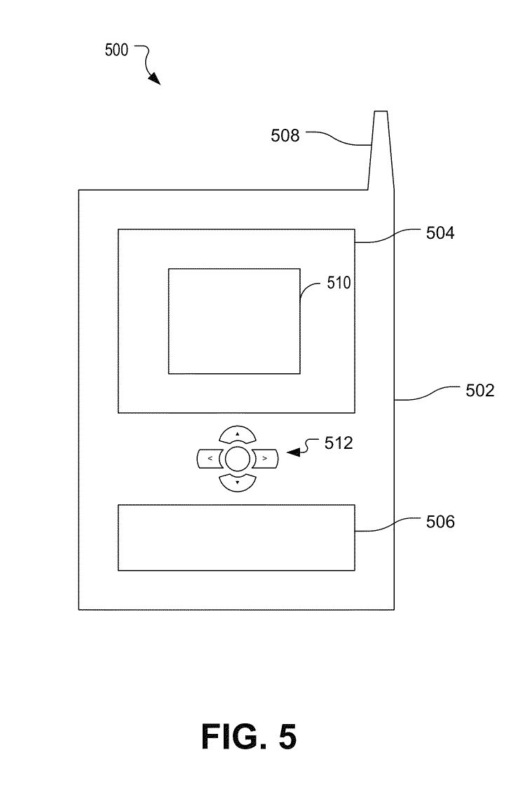

As described above, system 400 may be embodied in varying physical styles or form factors. FIG. 5 illustrates embodiments of a small form factor device 500 in which components of system 400 may be embodied. In embodiments, for example, device 500 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, gaming consoles, portable gaming devices, set-top-boxes, IPTV box, DVD players, Blu-ray players, or any playback capable devices.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 5, device 500 may comprise a housing 502, a display 504, an input/output (I/O) device 506, and an antenna 508. Device 500 also may comprise navigation features 512. Display 504 may comprise any suitable display unit such as a user interface 510 for displaying information appropriate for a mobile computing device. I/O device 506 may comprise any suitable I/O device for entering information into a mobile computing device. Examples for I/O device 506 may include an alphanumeric keyboard, a numeric keypad, a touch pad, input keys, buttons, switches, rocker switches, microphones, speakers, voice recognition device and software, and so forth. Information also may be entered into device 500 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, drivers, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments may therefore include a system including a video source to provide a video program and a video encoder to encode the video program with a corresponding rating for each frame of a plurality of frames of the video program based on the content of the frame. The video encoder may include first logic to launch a first user interface to enable a producer to rate a plurality of frames of the video program based on the content of the frame, and encode the video program with the corresponding rating for each frame of the plurality of frames of the video program. The system also may include a playback device to receive the encoded video program wherein the playback device includes second logic to launch a second user interface to enable a user to program the playback device to playback a video program based on frame level ratings of the video program.

Embodiments also may include a computer readable storage medium comprising a set of instructions which, if executed by a processor, cause a computer to receive a digital video program and encode the video program with a corresponding rating for each frame of a plurality of frames of the video program based on content of the frame.

Embodiments also may include a computer readable storage medium comprising a set of instructions which, if executed by a processor, causes a video playback device to receive a video program, wherein the video program is encoded with a corresponding rating for each frame of a plurality of frames of the video program based on content of the frame, set the playback device to playback the video program based on frame level ratings of the video program, and play the video program on the video playback device based on frame level ratings associated with one or more of a user input and a user profile.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A system comprising:
a video source to provide a video program; and
a video encoder to encode the video program with a corresponding rating for each frame of a plurality of frames of the video program based on content of the frame, wherein the video encoder includes first logic to,
launch a first user interface to enable a producer to rate a plurality of frames of the video program based on the content of the frame, and
encode the video program with the corresponding rating for each frame of the plurality of frames of the video program; and
a playback device to receive the encoded video program, wherein the playback device includes second logic to launch a second user interface to enable a user to program the playback device to playback a video program based on frame level ratings of the video program.

2. The system of claim 1, wherein the first logic is to encode a frame header of each frame of the plurality of frames of the video program with a corresponding rating based on the content of the frame.

3. The system of claim 1, wherein the first logic is to encode a video header of the video program with a corresponding rating for each frame of a plurality of frames of the video program based on the content of the frame.

4. The system of claim 1, wherein the video program is to be encoded based on an MPEG-2, MPEG-4, VC1, WMV, VP8, AVC, SVC, or uncompressed format.

5. The system of claim 1, wherein the second logic is to block from playback each frame of the video program that meets a frame level rating set by the user.

6. The system of claim 1, wherein the second logic is to, for each frame of one or more frames of the video program that meets a frame level rating set by the user, playback an alternate frame.

7. The system of claim 1, wherein the second logic is to distort each frame of the video program that meets a frame level rating set by the user.

8. The system of claim 1, wherein the second logic is to skip each frame of the video program that meets a frame level rating set by the user.

9. The system of claim 1, wherein the playback device further includes an integrated screen to display the video program.

10. A computer readable storage medium comprising a set of instructions which, if executed by a processor, cause a computer to:
receive a digital video program; and
encode the video program with a corresponding rating for each frame of a plurality of frames of the video program based on content of the frame.

11. The medium of claim 10, wherein to encode the video program includes encoding a frame header of each frame of the plurality of frames of the video program with a corresponding rating based on the content of the frame.

12. The medium of claim 10, wherein the instructions, if executed, cause a computer to launch a user interface to enable a producer to rate each frame of the plurality of frames of the video program.

13. The medium of claim 10, wherein to encode the video program includes encoding a video header of the video program with a corresponding rating for each frame of a plurality of frames of the video program based on the content of the frame.

14. The medium of claim 10, wherein the video program is to be encoded based on an MPEG-2, MPEG-4, VC1, WMV, VP8, AVC, SVC, or uncompressed format.

15. A computer readable storage medium comprising a set of instructions which, if executed by a processor, causes a video playback device to:
receive a video program, wherein the video program is encoded with a corresponding rating for each frame of a plurality of frames of the video program based on content of the frame;
set the playback device to playback the video program based on frame level ratings of the video program; and
play the video program on the video playback device based on frame level ratings associated with one or more of a user input and a user profile.

16. The medium of claim 15, wherein the instructions, if executed, cause the video playback device to launch a user interface to enable a user to set the playback device to playback a video program based on frame level ratings of the video program.

17. The medium of claim 15, wherein the instructions, if executed, cause the video playback device to block from playback each frame of the video program that meets a frame level rating.

18. The medium of claim 15, wherein the instructions, if executed, cause the video playback device to, for each frame of one or more frames of the video program that meets a frame level rating, play an alternate frame.

19. The medium of claim 15, wherein the instructions, if executed, cause the video playback device to distort each frame of the video program that meets a frame level rating.

20. The medium of claim 15, wherein the instructions, if executed, cause the video playback device to skip each frame of the video program that meets a frame level rating.
